(19) United States
(12) Patent Application Publication
(10) Pub. No.: US 2003/0102947 A1
(43) Pub. Date: Jun. 5, 2003

(54) Multipurpose input device

(76) Inventor: Joseph Ho, Kowloon (HK)

Correspondence Address: ROSENBERG, KLEIN & LEE, 3458 ELLICOTT CENTER DRIVE-SUITE 101, ELLICOTT CITY, MD, 21043, US

(21) Appl. No.: 10/002,104

(22) Filed: Dec. 5, 2001

(51) Int. Cl. H01F 38/20

(52) U.S. Cl. 336/174

(57) ABSTRACT

The present invention provides a multipurpose input device installed at a front stage of a power supply circuit. The multipurpose input device is formed by winding a fusible/resistance winding around a magnetic component having a high resistivity and a high permittivity. The fusible/resistance winding has the functions of a fusible link, an inrush current limiter, and an EMC choke. The conventional three separate subassemblies can be replaced with the multipurpose input device of the present invention to reduce the cost and shrink the volume. The present invention also conforms to the requirements of safety and EMC.

### FIELD OF THE INVENTION

The present invention relates to a multipurpose input device and, more particularly, to a multipurpose input device disposed at a front stage of a power supply circuit and capable of conforming to the requirements of safety and electromagnetic compatibility (EMC).

### BACKGROUND OF THE INVENTION

FIG. 1 shows a conventional conversion portion for converting an AC source into a DC one and widely used in the front stage design of a power supply circuit. A bridge rectifier D1-D4 is disposed in the conversion portion. The input end of the bridge rectifier D1-D4 is connected to an inrush current limiter 50 and then to a fusible link 60. The free end of the fusible link 60 is connected with an AC input source. The output end of the bridge rectifier D1-D4 is connected to an EMC choke 70 and a capacitor C. The EMC choke 70 and the free end of the capacitor C are connected to the follow-up portion of the power supply circuit.

The above conventional device accomplishes different functions by using the inrush current limiter 50, the fusible link 60, and the EMC choke 70. The fusible link 60 is a fuse, which will blow to break the circuit when the input current is too large. The input current can thus be limited within a safe value, e.g., below several amperes.

The inrush current limiter 50 is usually a low resistance component, which can increase the input impedance of an AC circuit to reduce the inrush current when a power source just plugs in, thereby avoiding damage of other components series-connected on the AC circuit or decrease of quality.

The EMC choke 70 is a basic electromechanical component for providing a high-frequency impedance between an applications equipment and the AC input source. Because the high-frequency impedance of the EMC choke can divide a voltage with the impedance of the AC input source, the differential-mode noise generated on the AC input source due to the applications equipment will decrease because of this voltage division. At high frequencies, because the high-frequency impedance of the EMC choke 70 is much larger than the impedance of the AC input source, the noise affecting the AC input source will be greatly reduced.

However, the cost is high because of a large number of subassemblies. Also, storage, conveyance, and installation cannot be reduced or simplified. Moreover, because the three subassemblies are individually joined, they cannot be effectively integrated to reduce the volume.

Accordingly, the present invention aims to provide a multipurpose input device, which has a low cost and a reduced volume, and conforms to the requirements of safety and EMC.

### SUMMARY OF THE INVENTION

The object of the present invention is to provide an input device having the functions of a fusible link, an inrush current limiter, and an EMC choke. A fusible resistance winding is wound around a magnetic component having a high resistance and a high permittivity. Because the input device of the present invention can replace the conventional three separate subassemblies, the object of reducing the cost and shrinking the volume can be accomplished.

The various objects and advantages of the present invention will be more readily understood from the following detailed description when read in conjunction with the appended drawing, in which:

### BRIEF DESCRIPTION OF THE DRAWINGS

FIG. 1 is a circuit diagram of a conventional converter for converting AC to DC;

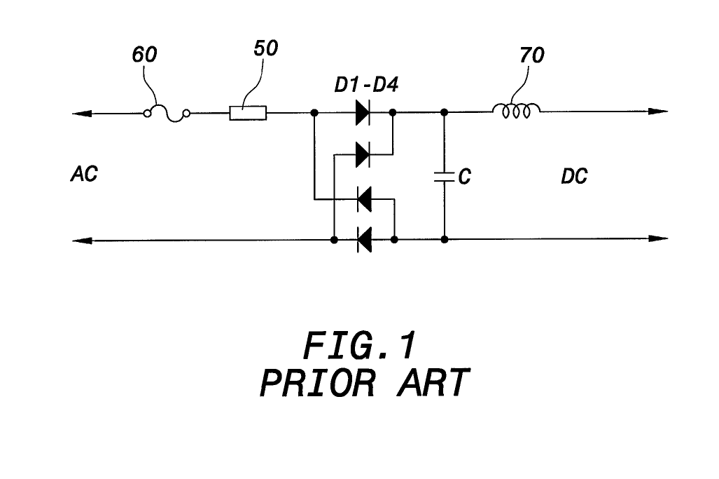

FIG. 2 is a circuit diagram of a converter for converting AC to DC of the present invention;

FIG. 3 is a perspective view of the present invention; and

FIG. 4 is a perspective view of another embodiment of the present invention.

### DETAILED DESCRIPTION OF THE PREFERRED EMBODIMENTS

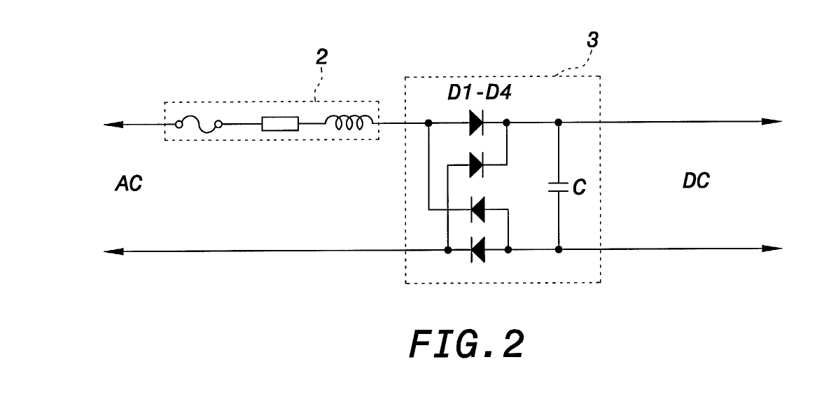

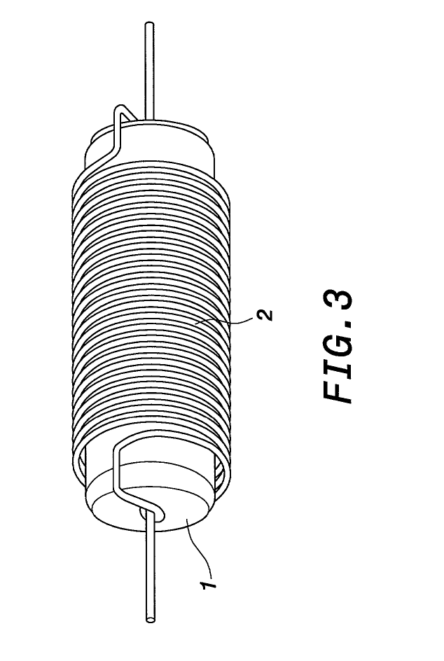

As shown in FIGS. 2 and 3, the present invention provides a multipurpose input device conforming to the requirements of safety and EMC. The multipurpose input device is series-connected between an AC input source and a rectifying circuit 3. In this embodiment of the present invention, the rectifying circuit 3 comprises a bridge rectifier D1-D4 and a capacitor C. The multipurpose input device comprises a magnetic component 1 and a resistance coil 2.

The magnetic component 1 is a magnetic core having ferromagnetic characteristic. The material of the magnetic core ought to have a high resistivity and a high permittivity to bear voltage difference generated when the resistance coil 2 blows; otherwise, it is also feasible to use an appropriate coil frame or package mechanism to separate the magnetic core from the circuit.

The resistance coil 2 is a fusible/resistance winding wound around the magnetic component 1. The resistance coil 2 has the functions of a fusible link, an inrush current limiter, and an EMC choke. That is, it can limit the input current within a safe value, reduce the inrush current, and choke the noise affecting the AC input source.

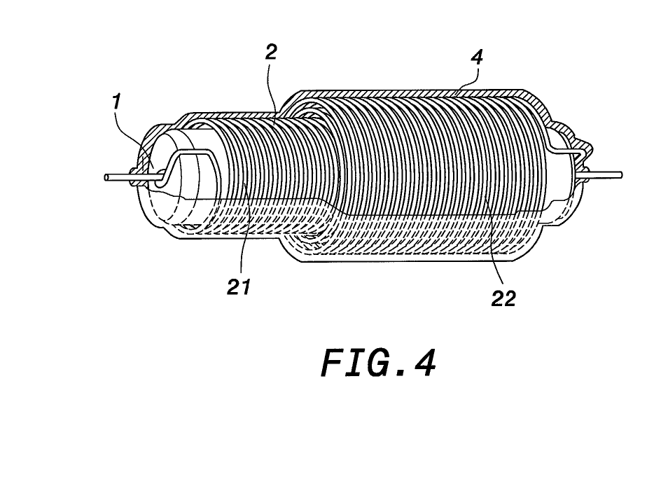

As shown in FIG. 4, the surface of the multipurpose input device of the present invention is coated with a covering layer 4 having protection effect to avoid smoke or fire when the resistance coil 2 blows.

Additionally, the resistance coil 2 can be formed by assembling a first coil 21 of a smaller number of turns with a second coil 22 of a larger number of turns. Because the first coil 21 has only a layer of winding, it can reduce parasitic capacitance to be advantageous for resisting high frequency. Parasitic capacitance between multiple layers of winding can be avoided, and a low-impedance leakage path is provided for the high-frequency current. The effective impedance of the coil is thus reduced. The second coil 22 is advantageous for resisting lower-frequency disturbance. Because of its structure of multiple layers of winding, a larger number of turns can be provided within a shorter length. For a cylindrical choke coil, the reactance is approximately proportional to the square of number of turns, and inversely proportional to the length. Therefore, a higher impedance for resisting low frequency can be obtained.

To sum up, the special design of the present invention has the following characteristics.

1. Low cost: Because a single component is used, the cost can be reduced, and conveyance and installation can be simplified.

2. Small volume: Because a single component is used to replace the conventional three separate subassemblies, the volume can be effectively shrunk.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A multipurpose input device series-connected between an AC input source and a DC circuit, comprising:
a magnetic core having ferromagnetic characteristic; and
a coil winding conforming to EMC being wound around said magnetic core, said coil winding having the functions of an inrush current limiter, a fusible link, and an EMC choke.

2. The multipurpose input device as claimed in claim 1, wherein said magnetic core has a high resistivity and a high permittivity.

3. The multipurpose input device as claimed in claim 1, wherein said magnetic core has an appropriate coil frame or package mechanism to separate from a circuit.

4. The multipurpose input device as claimed in claim 1, wherein said coil winding is a fusible/resistance winding.

5. The multipurpose input device as claimed in claim 1, wherein said coil winding can be formed by assembling a first coil of a smaller number of turns with a second coil of a larger number of turns.

6. The multipurpose input device as claimed in claim 1, wherein a surface thereof can be coated with a covering layer having protection effect.
